(19) United States
(12) Patent Application Publication
(10) Pub. No.: US 2011/0141047 A1
(43) Pub. Date: Jun. 16, 2011

(54) INPUT DEVICE AND METHOD

(75) Inventors: Tomoki Iwaizumi, Osaka (JP); Yutaka Kawase, Osaka (JP); Andrew Mcdonald, Osaka (JP)

(73) Assignee: KYOCERA CORPORATION, Kyoto-shi, Kyoto (JP)

(21) Appl. No.: 13/001,045

(22) PCT Filed: Mar. 27, 2009
(86) PCT No.: PCT/JP2009/056232

§ 371 Date: Feb. 14, 2011

(30) Foreign Application Priority Data
Jun. 26, 2008 (JP) 2008-167994 2008

(51) Int. Cl. G06F 3/041

(52) U.S. Cl. 345/173

(57) ABSTRACT

[Object] To provide an input device that allows a user to perceive readily individual virtual buttons without having to watch the virtual buttons carefully, thereby resulting in improved operability for the user.

[Constitution] An input device includes a touch panel 12 that accepts input from a user, a CPU 100 that receives input of a detection signal from the touch panel 12, and a vibration unit 111 that is driven and controlled by the CPU 100. The CPU 100 assigns a plurality of operation button fields on a detection surface of the touch panel 12 and, in response to a touch on an operation button field, causes the vibration unit 111 to vibrate in a vibration pattern set for the operation button field.

### TECHNICAL FIELD

The present invention relates to input devices for inputting information to apparatuses, and in particular, is preferred for use in portable terminal apparatuses such as mobile phones or personal digital assistants (PDAs).

### BACKGROUND ART

Conventionally, there have been known contact-type input devices such as touch panels. For example, some mobile phones and PDAs have transparent touch panels on display screens such as liquid crystal panels. When virtual buttons set on the touch panels are pressed by a user's finger or the like, input of information is performed.

On such input devices, virtual buttons do not have any tactile feel when being pressed, and therefore the input devices are generally equipped with means to notify a user that an operation is performed. For example, such notifying means generates vibrations when any virtual button is pressed, thereby notifying that input is correctly accepted (for example, refer to Patent Documents 1 and 2).

Patent Document 1: JP 2002-149312A

Patent Document 2: JP 2006-134085A

### DISCLOSURE OF THE INVENTION

### Problem to be Solved by the Invention

In many cases, contact-type input devices have even, flat input planes. In this situation, the user cannot perceive virtual buttons by the sense of touch even if sliding his/her finger over the input plane. Therefore, the virtual buttons are generally recognized depending on visual perception.

However, in some usage situations, it is desired that virtual buttons can be recognized with both visual and tactile senses, or only with a tactile sense. For example, in the case of writing a text of e-mail message, it may be desired for some users that information can be input mostly by touch-typing. In addition, contact input devices may have varied layouts of virtual buttons depending on the usage mode. In such a case, it is more difficult to input information by touch-typing.

Meanwhile, an arrangement for notifying an input operation by vibrations as described above makes merely a notification that a virtual button is pressed by vibrations, which cannot let a user perceive a virtual button before pressing the same. Accordingly, the arrangement cannot solve the above problem.

The present invention is devised to eliminate the foregoing problem. Accordingly, an object of the present invention is to provide an input device that allows easy input by virtual buttons, thereby improving operability for a user.

### Means to Solve the Problem

An input device in a first embodiment of the present invention includes: a touch detecting section that accepts input from a user; a button field assigning section that assigns a plurality of operation button fields on a detection surface of the touch detecting section; and a notifying section that makes a notification in a first notification mode set for the operation button field in response to a touch on the operation button field.

For example, the notifying section may be configured to determine that an operation button is touched if a barycenter of a touched portion on the detection surface is within the operation button field. In addition, the notification mode may be any one of vibration, sound, color, and brightness, or any combination of the same.

According to the input device of the first embodiment, if any operation button field is touched, a notification is made in the first notification mode set for the operation button field, which allows the user to perceive the presence of the operation button field from the notification.

Further, in the input device of the first embodiment, the notifying section may be configured to make a notification in a second notification mode different from the first notification mode when an area of a touched portion on the detection surface increases in the touched operation button field.

In such a configuration, when a user presses any portion in an operation button field and the area of the touched portion increases, a notification is made in the second notification mode. This allows the user to check that the operation button field is correctly pressed.

Further, in the input device of the first embodiment, the notifying section may be configured to make a notification in the second notification mode when the area in the touched operation button field increases and then decreases within a predetermined period of time.

In this configuration, a user can check that the operation button field is correctly pressed, as in the foregoing embodiment.

Further, in the input device of the first embodiment, the notifying section may be configured to, when the area in the touched operation button field increases and then does not decrease within the predetermined period of time, make a notification in a third notification mode in which the touched operation button field can be identified.

In such a configuration, the notification in the third notification mode allows a user to check whether the pressed operation button field is a desired operation button field. Then, after having checked that the pressed operation button field is correct, the user can relax the pressure of the finger to thereby complete the input operation.

Further, in the input device of the first embodiment, the notifying section may be configured to make a notification in the second notification mode when a notification is made in the third notification mode and then the area decreases in the touched operation button field.

In such a configuration, when the user relaxes the pressure of the finger after having checked that the pressed operation button field is correct, a notification is made in the second notification mode. Accordingly, the user can check that the input to the operation button field is correctly performed.

An input device in a second embodiment of the present invention includes: a touch detecting section that accepts input from a user; and a notifying section that, when any field assigned on a detection surface of the touch detecting section is touched, makes a notification in a notification mode set for the field.

According to the input device of the second embodiment, when any field assigned on the detection surface is touched, a notification is made in a notification mode set for the field, which allows a user to perceive the presence of the field from the notification.

As described above, according to the present invention, it is possible to allow a user to perform easy input by the virtual buttons, thereby improving operability for the user.

The foregoing and other advantages and significances of the present invention will be more fully understood from the following description of a preferred embodiment when reference is made to the accompanying drawings. However, the following embodiment is merely an example for carrying out the present invention, and the present invention is not limited by the following embodiment.

### BRIEF DESCRIPTION OF THE DRAWINGS

FIG. 1 is a diagram showing an external configuration of a mobile phone in an embodiment of the present invention;

FIG. 2 is a diagram showing an example of screen display and an example of virtual button settings in the embodiment;

FIG. 3 is a diagram showing relations between virtual buttons and operation button fields;

FIG. 4 is a block diagram showing an entire configuration of the mobile phone in the embodiment;

FIG. 5 is a diagram showing one example of a vibration pattern table in the embodiment;

FIG. 6 is a flowchart of a vibration control process in the embodiment;

FIG. 7 is a diagram for describing a specific example of notifications by vibrations in the embodiment;

FIG. 8 is a flowchart of a vibration control process in a modification example 1;

FIG. 9 is a diagram for describing a specific example of notifications by vibrations in the modification example 1;

FIG. 10 is a flowchart of a vibration control process in a modification example 2;

FIG. 11 is a diagram for describing a specific example of notifications by vibrations in the modification example 3; and

FIG. 12 is a diagram for describing shapes of operation button fields in the embodiment.

However, the drawings are only for purpose of description, and do not limit the scope of the present invention.

### BEST MODE FOR CARRYING OUT THE INVENTION

An embodiment of the present invention will be described below with reference to the drawings. In the example described below, an input device of the present invention is applied to a mobile phone. As a matter of course, the input device can be applied to other apparatuses such as PDAs.

In this embodiment, a touch panel 12 is equivalent to a “touch detecting section” recited in the claims. In addition, a “button field assigning section” and a “notifying section” recited in the claims are implemented as functions imparted to a CPU 100 by a control program stored in a memory 106.

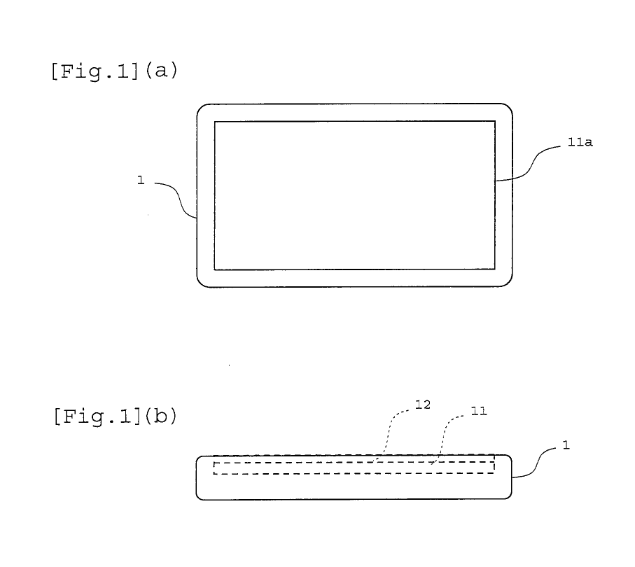

FIG. 1 is a diagram showing an external configuration of the mobile phone: FIGS. 1(a) and 1(b) are a front view and a side view of the mobile phone, respectively.

The mobile phone includes a cabinet 1 in the shape of a rectangular thin box. A liquid crystal display 11 is arranged within the cabinet 1. A display section 11a of the liquid crystal display 11 is exposed on an outside of a front surface of the cabinet 1.

A touch panel 12 is arranged on the display section 11a of the liquid crystal panel 11. The touch panel 12 is transparent and the display section 11a can be seen through the touch panel 12.

The touch panel 12 is a static touch sensor in which numerous detection elements are arranged in a matrix. Alternatively, any other static touch sensor different in structure may be used as touch panel 12. A detection signal from the touch panel 12 makes it possible to detect a position of a touch by a user on a detection surface (input coordinate) and an area of a touched portion.

The touch panel 12 may have on a front surface thereof a transparent protection sheet or protection panel. In this case, an externally exposed surface of the protection sheet or the protection panel constitutes a detection surface for input from a user. When the user touches the surface of the protection sheet or the protection panel, the touch panel 12 outputs a detection signal corresponding to a touched position in accordance with a change in capacitance. The touch detecting section recited in the claims includes an arrangement in which input by touching directly the surface of the touch panel 12 is accepted, and an arrangement in which input by touching the surface of the protection sheet or the like on the surface of the touch panel 12 is accepted, as described above.

This mobile phone can implement various function modes such as a telephone mode, a mail mode, a camera mode, and an Internet mode. The display section 11a of the liquid crystal display 11 shows an image in accordance with the currently implemented function mode.

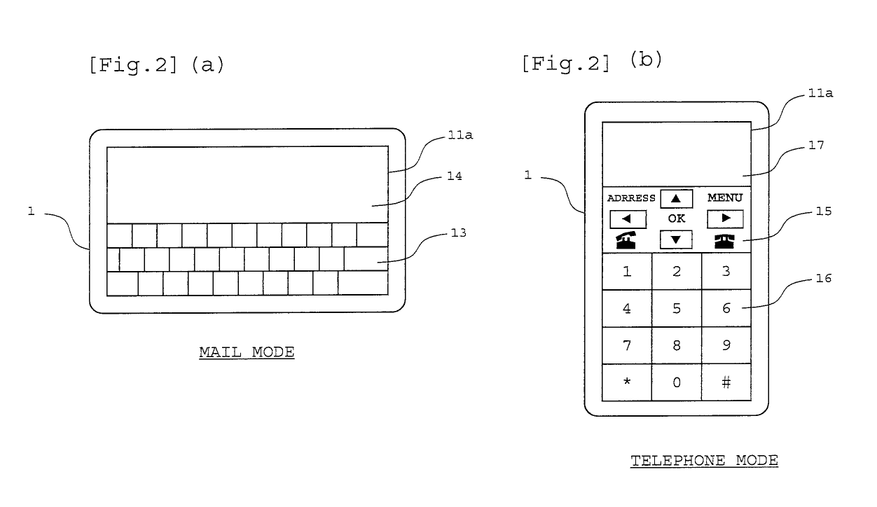

FIG. 2 is a diagram showing display examples of the liquid crystal display in accordance with the function modes: FIG. 2(a) shows a display example in the mail mode; and FIG. 2(b) shows a display example in the telephone mode.

As shown in FIG. 2(a), the apparatus in the mail mode is used in such a manner that shorter sides of the cabinet 1 are vertically positioned, for example. The display section 11a shows images of a full keyboard 13 and a mail information display screen 14. Characters and the like input from the full keyboard 13 are displayed on the mail information display screen 14.

As shown in FIG. 2(b), the device in the telephone mode is used in such a manner that longer sides of the cabinet 1 are vertically positioned, for example. The display section 11a shows images of a main button group 15, a number button group 16, and a telephone information display screen 17. The main button group 15 is constituted by a plurality of main buttons that are operated for starting and terminating a communication and searching for an address. The number button group 16 is constituted by a plurality of number buttons for inputting numbers, characters, and alphabets. The telephone information display screen 17 shows numbers and characters input by the number buttons. In FIG. 2(b) and the subsequent figures with the number buttons, the individual buttons are illustrated with only numbers shown thereon and hiragana characters and alphabets omitted for convenience in description.

The individual buttons in the full keyboard 13, the main button group 15, the number button group 16, are virtual buttons on the display section 11a. The touch panel 12 has operation button fields set for these virtual buttons. The operation button fields accept input operations.

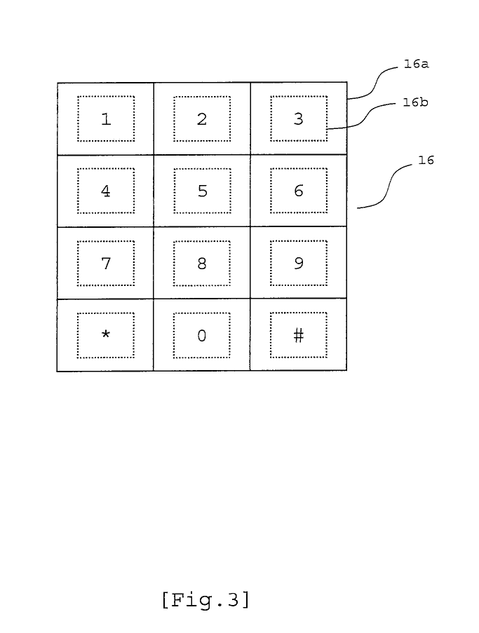

FIG. 3 is a diagram showing relations between the virtual buttons and the operation button fields in the number button group. As illustrated, operation button fields 16b are assigned on the touch panel 12 in correspondence with the individual number buttons 16a (virtual buttons). The operation button fields 16b are arranged at predetermined vertical and horizontal intervals. In this example, since the number buttons 16a are arranged at no vertical or horizontal intervals, the operation button fields 16b are smaller in size than the number buttons 16a. The number buttons 16a may have the same size as that of the operation button fields 16b. Alternatively, the number buttons 16a may be configured by only numbers without frames.

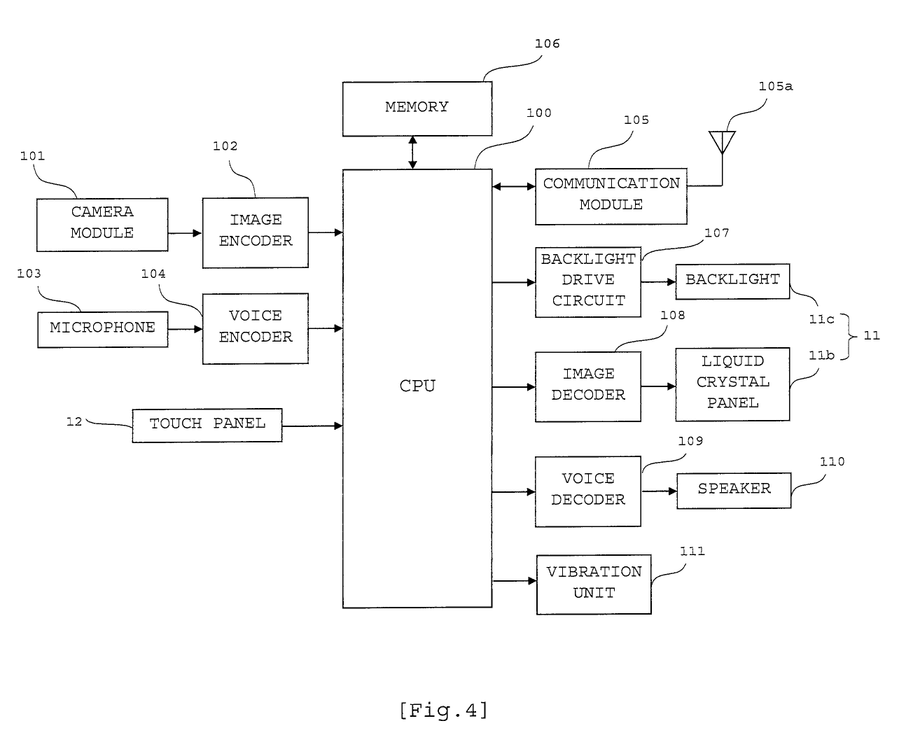

FIG. 4 is a block diagram showing an entire configuration of the mobile phone. Besides the foregoing constitutional elements, the mobile phone of this embodiment includes a CPU 100; a camera module 101; an image encoder 102; a microphone 103; a voice encoder 104; a communication module 105; a memory 106; a backlight drive circuit 107; an image decoder 108; a voice decoder 109; a speaker 110; and a vibration unit 111.

The camera module 101 has an imaging element such as a CCD to generate an image signal in accordance with a captured image and output the same to the image encoder 102. The image encoder 102 converts the image signal from the camera module 101 into a digital image signal capable of being processed by the CPU 100, and outputs the same to the CPU 100.

The microphone 103 converts an audio signal into an electric signal, and outputs the same to the voice encoder 104. The voice encoder 104 converts the audio signal from the microphone 103 into a digital audio signal capable of being processed by the CPU 100, and outputs the same to the CPU 100.

The communication module 105 converts audio signals, image signals, text signals, and the like from the CPU 100 into radio signals, and transmits the same to a base station via an antenna 105a. In addition, the communication module 105 converts radio signals received via the antenna 105a into audio signals, image signals, text signals, and the like, and outputs the same to the CPU 100.

The memory 106 includes a ROM and a RAM. The memory 106 stores control programs for imparting control functions to the CPU 100. In addition, the memory 106 stores data of images shot by the camera module 101, and image data, text data (mail data), and the like captured externally via the communication module 105, in predetermined file formats.

Further, the memory 106 stores layout information of the operation button fields on the touch panel 12 in accordance with the function modes, and stores a vibration pattern table.

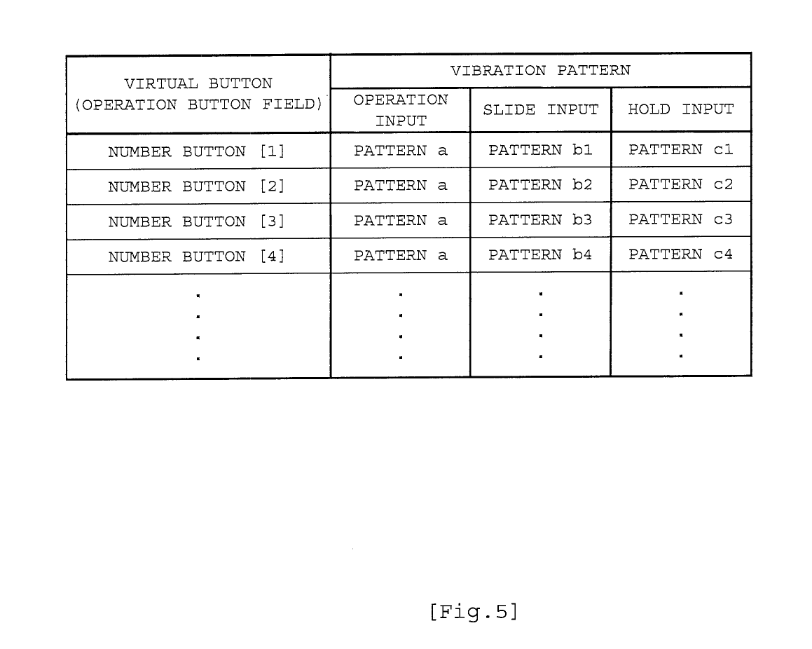

FIG. 5 is a diagram showing one example of a vibration pattern table. The vibration pattern table contains vibration patterns of the vibration unit 111 in correspondence with the virtual buttons (operation button fields), for individual input types (operation input, slide input, and hold input). In this example, the vibration pattern for operation input is uniform regardless of the virtual buttons, and the vibration patterns for slide input and hold input vary depending on the virtual buttons. The varying vibration patterns can be generated by setting different vibration frequencies, amplitudes, on/off time of an intermittent operation, or the like. The vibration pattern for slide input has relatively weak vibrations, whereas the vibration patterns for operation input and hold input have relatively strong vibrations.

The liquid crystal display 11 includes a liquid crystal panel 11b and a backlight 11c for supplying light to the liquid crystal panel 11b. The backlight drive circuit 107 supplies a voltage signal to the backlight 11c in accordance with a control signal from the CPU 100. The image decoder 108 converts the image signal from the CPU 100 into an analog image signal capable of being displayed on the liquid crystal panel 11b, and outputs the same to the liquid crystal panel 11b.

The voice decoder 109 converts an audio signal from the CPU 100 into an analog audio signal capable of being output from the speaker 110, and outputs the same to the speaker 110. The speaker 110 reproduces an audio signal as voice from the voice decoder 109.

The vibration unit 111 generates vibrations in accordance with a drive signal corresponding to the vibration pattern output from the CPU 100, and transfers the vibrations to the entire cabinet 1. That is, when the vibration unit 111 vibrates, the entire cabinet 1 including the touch panel 12 vibrates accordingly.

The CPU 100 performs processes in various function modes by outputting control signals to components such as the communication module 105, the image decoder 108, the voice decoder 109, and the like, in accordance with input signals from components such as the camera module 101, the microphone 103, and the touch panel 12. In particular, the CPU 100 sets operation button fields on the touch panel 12 in accordance with the function mode, and drives and controls the vibration unit 111 in accordance with a detection signal from the touch panel 12, as described later.

Meanwhile, in the mobile phone of this embodiment, a user operates virtual buttons on the display section 11a of the liquid crystal display 11, that is, operates the operation button fields on the touch panel 12, thereby to perform a predetermined input operation.

However, for an input operation from the touch panel 12 as described above, it is hard for the user to perceive individual virtual buttons only by the sense of touch. Accordingly, the user is required to watch carefully the individual virtual buttons before performing the input operation. This is because the surface of the touch panel 12 is flat and has no difference in level between a button layout plane and the buttons, unlike the case with press-type operation buttons, whereby the positions of the virtual buttons cannot be recognized with the tactile sense. In particular, if the layout pattern of the virtual buttons varies depending on the function mode as described above, it is difficult for the user to memorize thoroughly the positions of the virtual buttons.

Accordingly, in this embodiment, when touching the touch panel 12, the user is notified of the presence of the individual virtual buttons by vibrations, so that the user can readily understand the positions of the virtual buttons. A vibration control process for such a notification will be described below. The vibration control process is constantly performed while the apparatus can accept input.

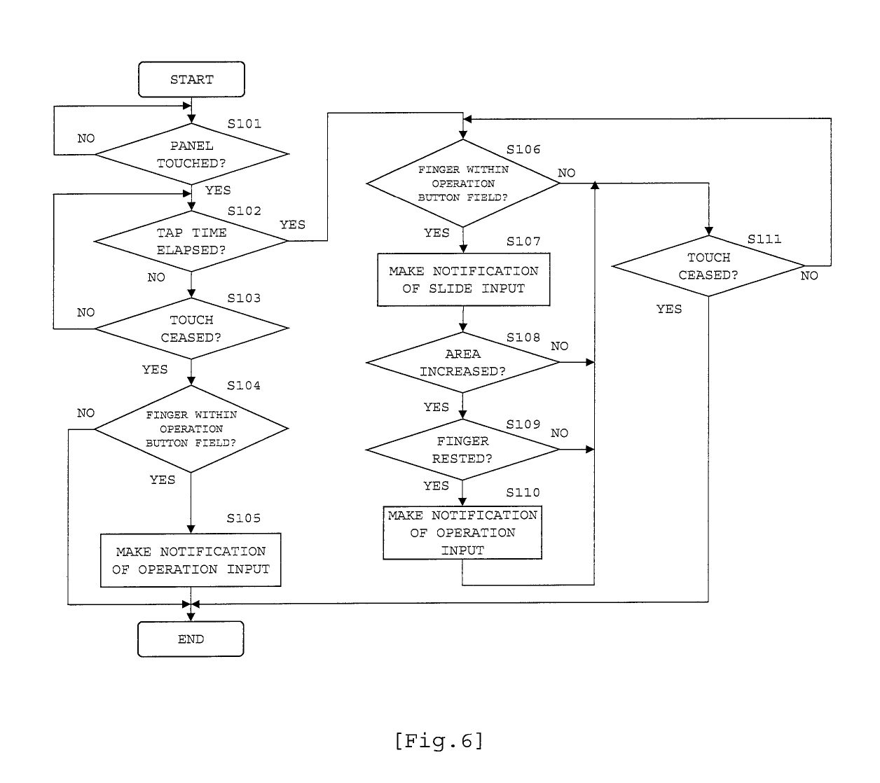

FIG. 6 is a flowchart of the vibration control process in this embodiment.

The CPU 100 receives input of a detection signal from the touch panel 12 at constant intervals (several ms, for example) in accordance with a predetermined clock frequency. Whenever receiving input of a detection signal, the CPU 100 detects whether the touch panel 12 is touched by a user's finger or the like. If the touch panel 12 is touched, the CPU 100 then determines an area and an input coordinate of a touched portion. The input coordinate is set as a barycenter coordinate of the touched portion. Specifically, the CPU 100 performs calculations for determining the area and the barycenter of the touched portion in accordance with a detection signal from the touch panel 12.

When the user touches the touch panel 12 (S101: YES), the CPU 100 starts to measure a tap time, and then determines whether the user has ceased to touch the touch panel 12 before a lapse of the tap time (S102 and S103).

The tap time here refers to a period of time that is preset considering a user's tapping on the touch panel 12 from the instant when the user's finger or the like touches the touch panel 12 to the instant when the user's finger or the like moves away from the touch panel 12. If the user has ceased to touch the touch panel 12 before a lapse of the tap time, it can be determined that the user has tapped the touch panel 12.

If determining that the user ceased to touch the touch panel 12 (tap input) before a lapse of the tap time (S103: YES), the CPU 100 then determines whether the touched position (input coordinate) is within any operation button field (S104). If the touch position is within any operation button field (S104: YES), the CPU 100 outputs a drive signal in a vibration pattern for operation input (hereinafter, referred to as “operation input pattern”) to the vibration unit 111 for a predetermined period of time, thereby causing the vibration unit 111 to vibrate in this vibration pattern for a predetermined period of time (S105). Accordingly, the user is notified that operation input is performed. In addition, the CPU 100 accepts input of a virtual button tapped at that time.

In contrast, if the touched position is not within any operation button field (S104: NO), the CPU 100 terminates this control process without doing nothing, and waits for the touch panel 12 to be touched next time (S101).

If the user's finger touches and holds the touch panel 12 until a lapse of the tap time, the CPU 100 determines that this input is not tap input, and performs S106 and subsequent steps. Specifically, if determining that the tap time has elapsed while the user continuously touches the touch panel 12 (S102: YES), the CPU 100 further determines whether the touched position is within any operation button field (S106). Then, if determining that the touched position is within any operation button field (S106: YES), the CPU 100 causes the vibration unit 111 to vibrate in a vibration pattern for slide input set for the operation button field (when a finger slides over the touch panel 12) (hereinafter, referred to as “slide input pattern) (S107). Accordingly, the user is notified that the virtual button is touched.

Next, the CPU 100 determines whether the area of the touched portion has increased (S108). For example, with each input of a detection signal from the touch panel 12, the CPU 100 determines an amount of increase of touched area from a difference between the current touched area and the touched area a predetermined period of time before. If the amount of increase exceeds a predetermined threshold value, the CPU 100 determines that the touched area has increased.

If determining that the touched area has increased (S108: YES), the CPU 100 then determines whether the user's finger or the like stays in that area (S109). For example, with each input of a detection signal from the touch panel 12, the CPU 100 determines an amount of change of input coordinate from a difference between the current input coordinate and the input coordinate a predetermined period of time before. If the amount of change is less than a predetermined threshold value, the CPU 100 determines that the user's finger or the like stays in the area.

When pressing a desired virtual button (operation button field), the user may first stop his/her finger on the virtual button and then apply the pressure of the finger to the button. Applying the pressure of the finger increases the touched area of the button. Accordingly, when the touched area of the virtual button increases and the finger stays on the virtual button, it can be determined that virtual button is pressed by the user.

If determining that the touched area has increased (S108: YES) and the finger or the like stays on the virtual button (S109: YES), the CPU 100 causes the vibration unit 111 to vibrate in the operation input pattern for a predetermined period of time (S110). Accordingly, the user is notified that operation input is performed. In addition, the CPU 100 accepts input of the virtual button pressed at that time.

Subsequently, the CPU 100 determines whether the user has ceased to touch the touch panel 12 (S111). Then, if determining that the user has ceased to touch the touch panel 12 (S111: YES), the CPU 100 terminates this control process. In contrast, if determining that the user still touches the touch panel 12 (S111: NO), the CPU 100 returns to step S106.

If determining at step S109 that the user has not press any virtual button and the area of the touched portion has not increased, or if determining at step S110 that the area of the touched portion has increased but the finger or the like has not stayed there, the CPU 100 then determines at step S111 whether the user has ceased to touch the touch panel 12. Then, if determining that the user still touches the touch panel 12 (S111: NO), the CPU 100 returns to step S106.

If the user's finger stays within any operation button field and the user does not apply the pressure to the button or move the finger away from the button, the CPU 100 performs repeatedly step S106 through step S108 (determination: NO) or step S109 (determination: NO) to step S111 (determination: NO). In the meanwhile, the CPU 100 also performs step S107 continuously to cause continuous vibrations in the slide input pattern.

Next, if the user moves the finger away from the operation button field, the CPU 100 determines at step S106 that the touched position is not within any operation button field. Then, the CPU 100 determines whether the user has ceased to touch the touch panel 12 (S111). If determining that the user still touches the touch panel 12 (S111: NO), the CPU 100 returns to step S106. During repeated execution of steps S106 and S111, the CPU 100 does not perform step S107 to stop vibrations.

After that, if the user's finger touches the touch panel 12 and enters again any operation button field, the CPU 100 determines at step S106 that the touched position is within the operational button field (S106: YES), and causes the vibration unit 111 to vibrate in the slide input pattern set for the operation button field (S107).

In contrast, if determining that the user has ceased to touch the touch panel 12 during repeated execution of steps S106 and 5111 (S111: YES), the CPU 100 terminates this control process.

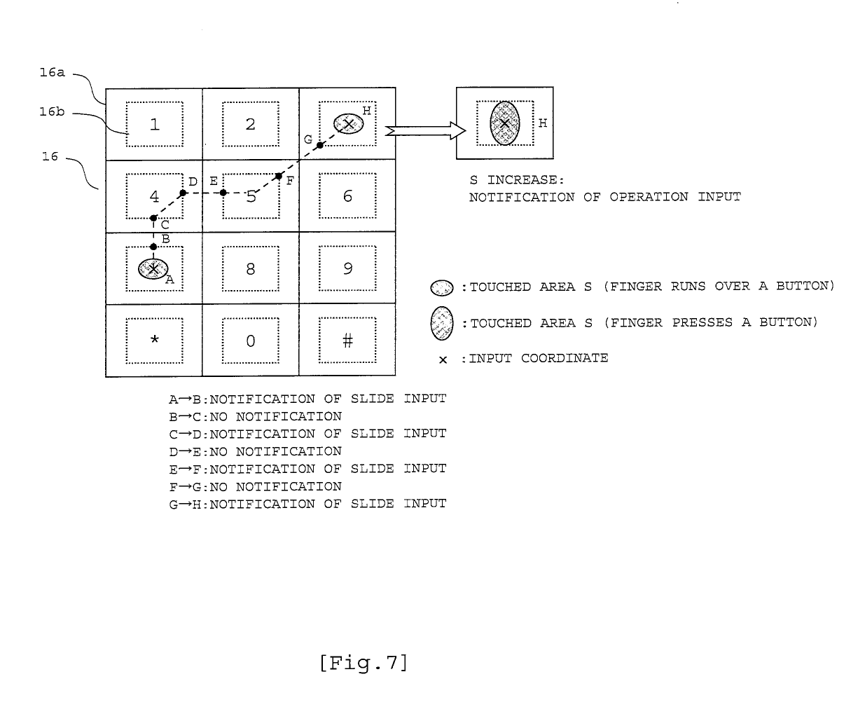

FIG. 7 is a diagram for describing an example of notifications by vibrations to be made when a user performs an input operation. In this example, the user gropes for the number buttons 16a by his/her finger to perform the input operation in the telephone mode.

If the user touches by his/her finger the operation button field 16b for the “7” number button 16a and does not immediately move the finger away from the field, steps 106 to S107 are carried out and the cabinet 1 vibrates in the slide input pattern set for the “7” number button 16a. At that time, the vibrations are relatively weak. The user can feel the vibrations by the hand holding the cabinet 1 and the finger touching the touch panel 12, thereby to understand that the finger is positioned on the “7” number button 16a.

After that, if the user is moving the finger toward the “4” number button 16a, the vibrations continue while the finger is in touch with the “7” operation button field 16b (A to B). When the finger is out of the “7” operation button field 16b, steps S106 to S111 are carried out to stop the vibrations until the finger enters the “4” operation button field 16b (B to C).

Then, after the finger has entered the “4” operation button field 16b, the cabinet 1 vibrates in the slide input pattern set for the “4” operation button field 16b while the finger is within the field (C to D). Accordingly, the user can understand that the finger is positioned on the “4” number button 16a.

Subsequently, as shown in FIG. 7, if the finger then passes through the “5” number button 16a and moves to the “3” number button 16a, the cabinet 1 does not vibrate while the finger moves from the “4” to “5” operation button fields 16b (D to E) and from the “5” to “3” operation button fields 16b (F to G). Meanwhile, while the finger is within the “5” operation button field 16b (E to F) and within the “3” operation button field 16b (G to H), the cabinet 1 vibrates in the slide input patterns set for the “5” and “3” number buttons 16a, respectively. Accordingly, the user can understand that the finger is positioned on the “5” and “3” number button 16a, respectively.

After having reached the “3” number button 16a, if the user applies the pressure of the finger to the number button 16a without moving the finger away from the number button 16a, the touched area increases with the finger staying on the button, and therefore the process moves from steps S108 to S110. Accordingly, the cabinet 1 vibrates in the operation input pattern. At that time, the vibrations are relatively strong and last for a short time. The user can feel the vibrations by his/her finger or hand to thereby check that the operation input of the “3” number button 16a is completed (the operation input is accepted).

The touched area increases also when the user applies temporarily the strong pressure of the finger to the touch panel 12 while moving the finger over the touch panel 12. However, in this vibration control process, it is not recognized that the number button is pressed even if the touched area has increased, as far as the finger does not stay on the button (S109: NO). Accordingly, no vibrations for operation input are generated by mistake.

As described above, according to this embodiment, when a user simply touches any operation button field for a virtual button (such as a number button 16a), a notification is made by vibrations set for the operation button field. Accordingly, the user can perceive the presence of the virtual button from the vibrations. This allows the user to perform an input operation without having to watch the virtual buttons carefully, thereby resulting in improved operability for the user.

In addition, according to this embodiment, different vibration patterns are set depending on the virtual buttons (operation button fields), which allows a user to identify the individual virtual buttons from vibrations, thereby improving operability for the user.

Further, according to this embodiment, there are predetermined intervals between adjacent operation button fields, and no vibrations are generated between two each operation button fields. Therefore, while a user moves his/her finger over the touch panel 12, if vibrations are stopped in any section having no virtual button, the user can perceive accurately movement to a next virtual button.

Moreover, according to this embodiment, when a user presses any operation button field and the area of the touched portion increases, a notification of operation input is provided. Accordingly, the user can check that the operation input is correctly performed.

Although the embodiment of the present invention is as described above, the present invention is not limited to by this embodiment. Besides, the embodiment of the present invention can be further modified as described below.

### Modification Example 1

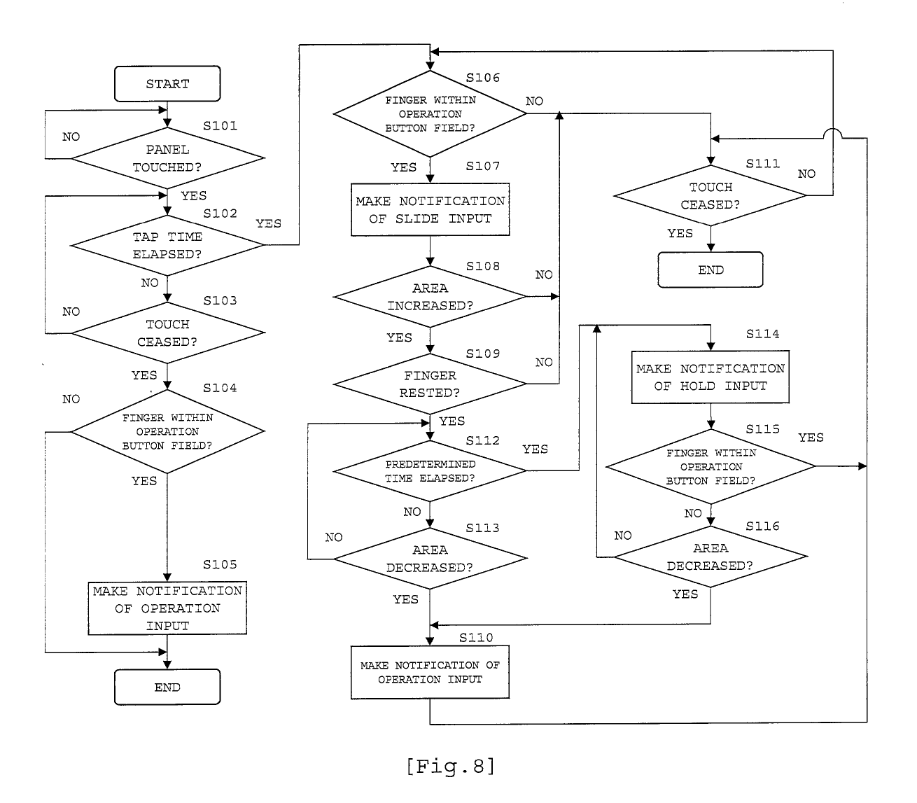

FIG. 8 is a flowchart of a vibration control process in a modification example 1. In FIG. 8, the same steps as those in the foregoing embodiment are given the same step numbers as those in the foregoing embodiment.

The modification example 1 is different from the foregoing embodiment, in operations to be performed when a user presses a virtual button in an operation button field. Only operations different from those in the foregoing embodiment will be described below.

If determining that the user has applied the pressure of the finger to thereby increase the touched area (S108: YES) and the finger stays there (S109: YES), the CPU 100 then determines whether the increased touched area has subsequently decreased again before a lapse of a prescribed period of time (S112 and S113).

For example, after having determined that the touched area has increased (S108: YES), the CPU 100 then determines an amount of decrease of touched area from a difference between the current touched area and the touched area a certain period of time before. If the amount of decrease exceeds a predetermined threshold value, the CPU 100 determines that the touched area has decreased. As a matter of course, the CPU 100 also determines that the touched area has decreased if the user has ceased to touch the touch panel 12.

If determining that the touched area has decreased within the prescribed period of time because the user has relaxed immediately the pressure of the finger (S113: YES), the CPU 100 causes the vibration unit 111 to vibrate in the operation input pattern for a certain period of time (S110). Accordingly, the user is notified that the operation input is performed. In addition, the CPU 100 accepts input of the virtual button pressed at that time.

In contrast, if the user continuously applies the pressure of the finger after a lapse of a predetermined period of time while the amount of decrease of touched area does not exceed the predetermined threshold value (S112: YES), the CPU 100 causes the vibration unit 111 to vibrate in a vibration pattern for hold input (when the user presses and holds the touch panel 12 by his/her finger) set for the operation button field (hereinafter, referred to as “hold input pattern”) (S114). Accordingly, the user is notified that operation input of the virtual button is being performed. The vibrations at that time are generated in a pattern specific to each of the virtual buttons as shown in the table of FIG. 5. This allows the user to identify the virtual button pressed by the finger from the vibrations.

Next, the CPU 100 determines whether the touched position is out of the operation button field (S115), and further determines whether the touched area has decreased (S116).

If the user presses and holds the operation button field by the finger (S115: NO), the CPU 100 repeats steps S114 to S116, during which vibrations are continuously generated in the hold input pattern.

After that, if the user relaxes the pressure of the finger, the CPU 100 determines that the touched area has decreased (S116: YES), and causes the vibration unit 111 to vibrate in the operation input pattern for a certain period of time (S110). Accordingly, the user is notified that the operation input is performed. In addition, the CPU 100 accepts input of the virtual button pressed at that time.

In contrast, if the user moves the pressing finger away from the operation button field (S115: YES), the CPU 100 moves directly to step S111. In this case, no vibrations are generated in the operation input pattern even if the user relaxes the pressure of the finger later. In addition, the CPU 100 does not accept input of the virtual button.

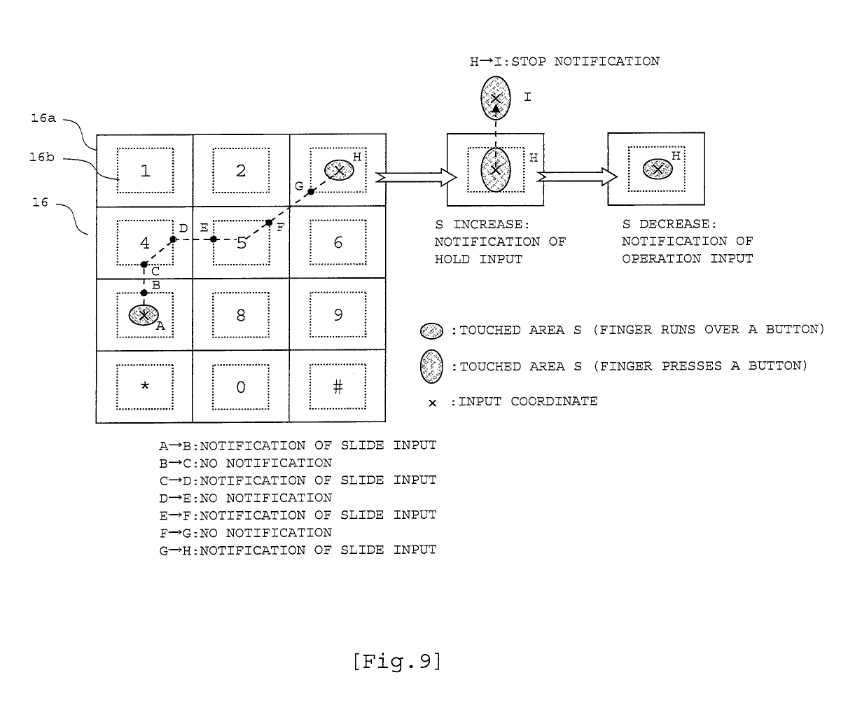

FIG. 9 is a diagram for describing one example of notifications by vibrations to be made when a user performs an input operation.

In this example, if the user presses and holds the number button 16a with his/her finger in the “3” operation button field 16b and does not relax the pressure of the finger immediately, the process moves from steps S112 to S114. Accordingly, the cabinet 1 vibrates in the hold input pattern set for the “3” number button 16a. At that time, the vibrations are relatively strong. In this state, the input operation is not yet completed and the input is not accepted. From the vibrations at that time, the user can check finally whether the number button 16a is a desired button.

Then, if the number button 16a is a desired button, the user relaxes the pressure of the finger. Accordingly, the input operation is completed, and steps S112 and S114 are carried out to vibrate the cabinet 1 in the operation input pattern. The user can check from the vibrations that the input is accepted.

In contrast, if the number button 16a is not a desired button, the user moves the pressing finger away from the “3” operation button field 16b. Accordingly, the process moves from S115 to S111 to stop the vibrations in the hold input pattern. After that, even if the user relaxes the pressure of the finger, the input is not accepted and the cabinet 1 does not vibrate in the operation input pattern.

As described above, according to the configuration of the modification example 1, when pressing and holding any virtual button with his/her finger, the user can check whether the pressed button is a desired button, and then can complete or stop the operation input depending on a result of the checking. This results in improved operability for the user.

In addition, according to the configuration of the modification example 1, if the user relaxes the pressure of the finger after checking that the pressed virtual button is a desired button, the user is notified that the input operation is performed. Accordingly, the user can perform the operation input of the virtual button more accurately.

### Modification Example 2

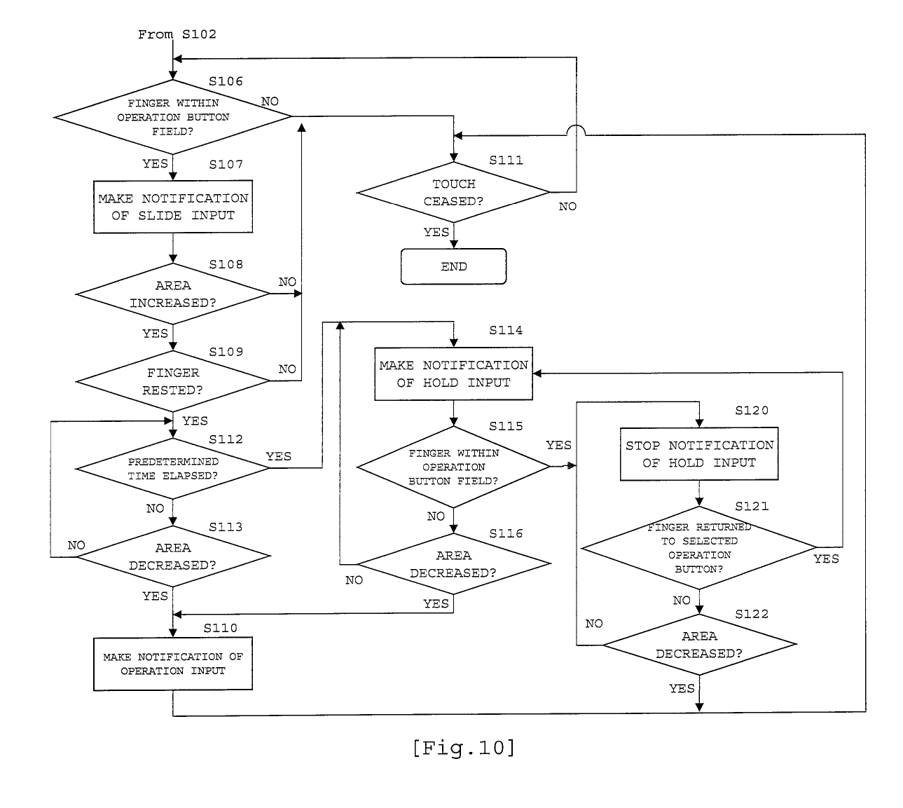

FIG. 10 is a flowchart of a vibration control process in a modification example 2. In FIG. 10, the same operations as those in the foregoing embodiment and the modification example 1 are given the same step numbers as those in the foregoing embodiment and the modification example 1.

The modification example 2 is different from the modification example 1 in operations to be performed after it is determined at step S115 that a user's finger is out of the operation button field while vibrations are generated in the hold input pattern. Only the operations different from those of the modification example 1 will be described below.

If the user shifts the finger away from the operation button field without relaxing the pressure, the CPU 100 determines that the touched position is out of the operation button field (S115: YES). Accordingly, the CPU 100 causes the vibration unit 111 to stop vibrations (S120). Then, the CPU 100 determines whether the user's finger has returned to the previous operation button field while the touched area has not decreased (the finger holds the field) (S121). If determining that the finger has returned to the previous operation button field (S121: YES), the CPU 100 returns to step S114 to cause the vibration unit 111 to vibrate again in the hold input pattern.

In contrast, if determining that the touched area has decreased (the pressure of the finger has been relaxed) while the finger has not returned to the previous operation button field (S122: YES), the CPU 100 performs step S111. If the finger is not moved (S111: NO), the CPU 100 performs S106 and subsequent steps.

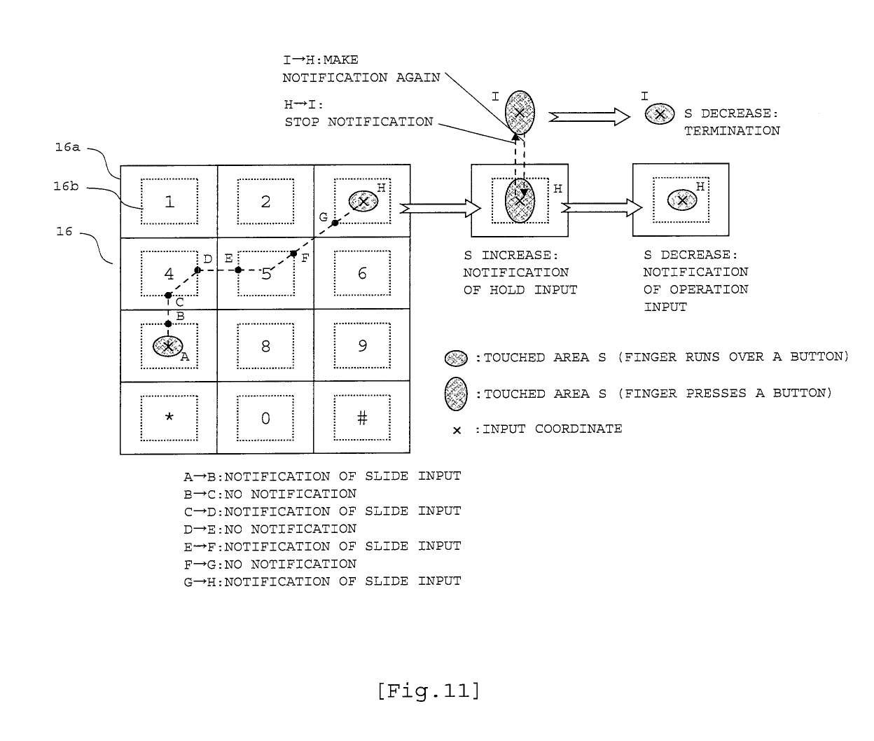

FIG. 11 is a diagram for describing one example of notifications by vibration to be made when a user performs an input operation, in a modification example 2.

In this example, when the user shifts the finger away from the “3” operation button field 16b without relaxing the pressure, S115 and S120 are carried out to stop temporarily vibrations in the hold input pattern.

In this state, if checking finally that the “3” operation button field 16b is a desired button, the user returns the finger to the “3” operation button field 16b without relaxing the pressure of the finger. Accordingly, step S115 is carried out to vibrate the cabinet 1 again in the hold input pattern. After that, if the user relaxes the pressure of the finger, the cabinet 1 vibrates in the operation input pattern and the input of the “3” number button 16a is accepted.

As described above, according to the configuration of the modification example 2, the user can shift the finger temporarily from an operation button field, check the virtual button, and then return the finger to the operation button field to thereby complete operation input.

### <Others>

The embodiment of the present invention can be modified in various manners besides the above-described ones. For example, in the foregoing embodiment, the different vibration patterns for slide input and hold input are set for the individual virtual buttons. However, variations of vibration patterns are not limited to the foregoing ones. Alternatively, only vibration patterns for some of the virtual buttons may be different from those for the other virtual buttons. Further alternatively, vibration patterns may be made different among predetermined groups of virtual buttons.

With regard to the number buttons described above in relation to the foregoing embodiment, for example, the vibration pattern for the centrally located “5” number button may be different from those for the other number buttons. Alternatively, the vibration patterns may be different by horizontal or vertical line of number buttons.

Alternatively, the vibration pattern for slide input may be unified for all the virtual buttons, so that the user is notified only which of the virtual buttons his/her finger has entered.

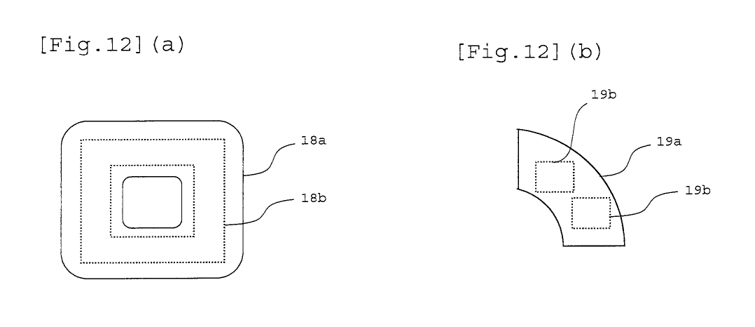

Further, although the operation button fields 16b of the number buttons 16a are described above in relation to this embodiment, similar operation button fields are set for other virtual buttons. The operation button fields for the other virtual buttons may have various shapes and sizes in accordance with shapes and sizes of virtual buttons 18a and 19a, as with the operation button fields 18b and 19b shown in FIGS. 12(a) and 12(b). Alternatively, those virtual button fields may be configured so as to be capable of being freely changed by the user in accordance with his/her finger size or the like.

Further, the foregoing embodiment is configured to notify the presence of virtual buttons by vibrations. However, the foregoing embodiment is not limited to by this notification method, and therefore a notification may be made by sound from the speaker 110. Alternatively, a notification may be made by display changes in color or brightness on the display section 11a. As a matter of course, these methods may be combined.

In addition, the foregoing embodiment uses the static touch panel 12, but is not limited to by this touch panel. Therefore, any other type of touch panel, for example, a pressure-sensitive touch panel may be used instead.

Further, the foregoing embodiment uses the liquid crystal display 11 as a display device, but is not limited to by this display. Therefore, any other type of display such as an organic EL display may be used instead.

Moreover, in the foregoing embodiment, if it is determined that a touched position is within any operation button field, a notification is made that the touched position is within the operation button field (by vibrations in the slide input pattern, for example). Alternatively, if any field other than operation button fields on the detection surface of the touch panel 12 is touched, a notification may be made in a notification mode for the field (by vibrations, sound or the like). For example, a mark field not contributing to any operation input may be preset in the course of a user's finger moving from one operation button field to another. While the mark field is touched, it is notified that the finger is within the mark field. This allows the user to move the finger from one operation button field to another with improved operability. In addition, such a mark field may be set out of the foregoing course at a predetermined reference position. In this case, the user can perceive the positions of operation button fields with the mark field as a reference point, and can move the finger smoothly to a desired operation button field.

Besides, the embodiments of the present invention may be alternatively modified in various manners within the scope of technical ideas recited in the claims.

1. An input device comprising:
a touch detecting section that accepts input from a user; a button field assigning section that assigns a plurality of operation button fields on a detection surface of the touch detecting section; and a notifying section that makes a notification in a first notification mode set for the operation button field in response to a touch on the operation button field.

2. The input device according to claim 1, wherein
the notifying section makes a notification in a second notification mode different from the first notification mode when an area of a touched portion on the detection surface increases in the touched operation button field.

3. The input device according to claim 2, wherein
the notifying section makes a notification in the second notification mode when the area in the touched operation button field increases and then decreases within a predetermined period of time.

4. The input device according to claim 3, wherein
when the area in the touched operation button field increases and then does not decrease within the predetermined period of time, the notifying section makes a notification in a third notification mode in which the touched operation button field can be identified.

5. The input device according to claim 4, wherein
the notifying section makes a notification in the second notification mode when a notification is made in the third notification mode and then the area decreases in the touched operation button field.

6. The input device according to claim 1, wherein
the notifying section determines that an operation button is touched if a barycenter of a touched portion on the detection surface is within the operation button field.

7. The input device according to claim 1, wherein
the notification mode is any one of vibration, sound, color, and brightness, or any combination of the same.

8. An input device comprising:
a touch detecting section that accepts input from a user; and a notifying section that, when any field assigned on a detection surface of the touch detecting section is touched, makes a notification in a notification mode set for the touched field.

9. An inputting method for an input device with a touch detecting section and a notifying section, the inputting method comprising steps of:
accepting input from a user through the touch detecting section; and
making a notification with the notifying section when any field assigned on a detection surface of the touch detecting section is touched, the notification being performed in a notification mode set for the touched field.
